(19) United States
(12) Patent Application Publication
(10) Pub. No.: US 2011/0093525 A1
(43) Pub. Date: Apr. 21, 2011

(54) SYSTEM AND METHOD FOR PROFILING REMOTE USER INTERFACE

(75) Inventors: Se-Hee Han, Seoul (KR); Joo-Yeol Lee, Seoul (KR); Seung-Jae Oh, Seoul (KR); Dong-Shin Jung, Suwon-si, (KR); Won-Seok Kwon, Suwon-si (KR)

(73) Assignee: SAMSUNG ELECTRONICS CO., LTD., Suwon-si (KR)

(21) Appl. No.: 12/865,587

(22) PCT Filed: Jan. 30, 2009
(86) PCT No.: PCT/KR2009/000445

§ 371 Date: Dec. 9, 2010

(30) Foreign Application Priority Data
Feb. 1, 2008 (KR) 10-2008-0010665

(51) Int. Cl. G06F 15/16

(52) U.S. Cl. 709/203

(57) ABSTRACT

Provided are a network system and method for profiling a remote user interface (RUI), and more particularly, a network system and method for performing optimal RUI profile matching between an RUI client and an RUI server in order for optimal service adaptation for various contents based on composite capabilities/preference profiles (CC/PP).

### TECHNICAL FIELD

The present invention relates to a network system and method for profiling a remote user interface (RUI), and more particularly, to a network system and method for performing optimal RUI profile matching between an RUI client and an RUI server in order for optimal service adaptation of various contents based on composite capabilities/preference profiles (CC/PP).

### BACKGROUND ART

With the development of wired and wireless communication networks, Internet technology has advanced more than ever. Accordingly, various Internet-enabled mobile devices have been developed. These Internet-enabled mobile devices and embedded computing technology are ushering in a ubiquitous era in which computer technology can be utilized anytime and anywhere.

Flexible, portable and sophisticated devices, such as plasma display panels (PDPs), personal digital assistants (PDAs), mobile phones and telematics devices, are becoming more varied and essential in people's lives. Thus, people are demanding more rich and various contents, which can be provided on personal computers, on their mobile devices.

In order to provide optimal services that can satisfy various user preferences, optimal content adaptation and implementation of an optimal computing environment are required. Through optimal content adaptation and implementation of the optimal computing environment, optimal services can be provided to heterogeneous client devices, which are available now, as well as those having new functions and constraints which will be introduced in the future.

However, as the number of heterogeneous devices increases, it is becoming more complicated to develop applications optimized for different operating environments of the devices that will provide services, that is, different capabilities (i.e., hardware, software and network characteristics) of the devices and user preferences. It would be most desirable if service providers or service developers can develop and provide services that are tailored to various devices and user preferences. However, it is realistically impossible. Thus, for now, service providers or service developers have to develop different versions of the same service according to characteristics of each device, which results in a significant waste of time and costs.

To address this problem, a device-independent profiling system and method, which can support various devices individually, are needed. If the device-independent profiling system and method are used, various contents requested by client devices having different operating environments can be easily converted into a format optimized for characteristics of each client device and provided in the format. In addition, the cost of unnecessary service development can be sharply reduced.

In order to provide device-independent services based on characteristics of each device, information regarding the environment of each device is essential. The information regarding the environment of each device includes hardware, software and network characteristics of each device as well as parameter values for additional applications, such as user preferences, the location of a user and a language used by the user. In order for a server to be able to provide an optimized service to a user's terminal based on profile information of the terminal, i.e., information regarding the environment of the terminal, content negotiation and content adaptation are required. Content negotiation and content adaptation are about how to efficiently match profile information of the user's terminal and that of the server.

Specifically, content negotiation refers to a process of examining and analyzing characteristics of a client, characteristics of a server, network characteristics, and environmental constraints (hereinafter, referred to as “context”), that is, a process of examining and analyzing remote user interface (RUI) profile related information for optimally matching RUI profiles of a client and a server (analyzing remote user interface (RUI) profiles of a client and a server to create an optimal RUI profile). Content adaptation may be achieved by providing optimal client platform profile information, which is obtained after content negotiation, to a target client.

Hereinafter, a Consumer Electronics Association (CEA)-2014 standard, which is a conventional browser-based RUI standard for content negotiation and content adaptation, will be described in detail.

FIG. 1 schematically illustrates a structure 100 of a conventional CEA-2014 standard. Referring to FIG. 1, the CEA-2014 standard may include an RUI client 110, an RUI server 120, and a UI control point (UICP) 130.

The RUI client 110 renders and controls an RUI received from the RUI server 120. The RUI server 120 may provide one or more RUIs. The UICP 130 detects the RUI client 110 and the RUI server 120 and sets the connection between them.

When the RUI client 110 requests the RUI server 130 to provide desired content, the RUI client 110 and the RUI server 120 exchange their own RUI profile information with each other through the UICP 130. Then, through content negotiation, optimal profile matching is performed. Consequently, extensible hypertext markup language (XHTML) content, which is optimized for the RUI client 110, can be provided to the RUI client 110.

The conventional CEA-2014 standard may define, within its specifications, RUI profile information that is exchanged in the process of content negotiation to provide a service optimized for a client terminal. For example, the conventional CEA-2014 standard may define a) specifications of the RUI client 110 and the RUI server 120, b) specifications of the interaction between the RUI client 110 and the RUI server 120, c) specifications of the interaction between the RUI client 110 and the RUI server 120 through the Internet, and d) specifications of a new browser (e.g., CE-HTML) required by the RUI client 110. Regions in which services optimized for the RUI client 110 can be and cannot be provided according to the above four RUI specifications are illustrated in FIG. 1.

FIG. 2 illustrates an example of an RUI profile based on the conventional CEA-2014 standard. Referring to FIG. 2, the RUI profile describes the RUI profile information of the RUI client 110 and the RUI server 120 in an extensible markup language (XML) tag format which is defined in the CEA-2014 standard specifications. That is, the RUI profile contains tags and values for characteristic values of an RUI, such as font type, information regarding whether or not scroll keys, navigation keys, or play control keys exist, and information regarding whether to download content.

### DISCLOSURE OF INVENTION

### Technical Problem

A remote user interface (RUI) profile based on the conventional CEA-2014 standard is designed to describe only browser characteristics and content adaptation through home local area network (LAN) or general Internet technology (excluding specialized streaming technology). Thus, the RUI profile based on the conventional CEA-2014 standard cannot be fully utilized for content negotiation in various device environments.

The present invention provides a network system and method for profiling a remote user interface (RUI) which contains parameter values for additional applications, such as user preferences, the location of a user and a language used by the user, as well as various characteristics (e.g., hardware, software and network characteristics, and supported service information) of a terminal.

However, the objectives of the present invention are not restricted to the one set forth herein. The above and other objectives of the present invention will become more apparent to one of ordinary skill in the art to which the present invention pertains by referencing a detailed description of the present invention given below.

### Technical Solution

According to an aspect of the present invention, there is provided a network system for profiling a remote user interface (RUI) (for creating and providing an optimal remote user interface (RUI) profile?). The network system includes: at least one RUT client; and at least one RUI server receiving first profiling request information from the at least one RUI client and transmitting first profiling response information to the at least one RUI client in response to the received first profiling request information.

The at least one RUI client may include: a first profile repository storing and managing first profile information which is related to profile characteristics of the at least one RUI client; a profile repository locator (PRL) storing PRL information which is location information of the first profile repository; and a browser transmitting the first profiling request information and the PRL information when the at least one RUI client makes a profiling request, receiving the first profiling response information, and displaying the received first profiling response information.

The at least one RUI server may include: a second profile repository storing and managing second profile information, which is related to profile characteristics of the at least one RUI server, and new or additional information which may be created at the request of the at least one RUI client; a profile handler accessing the first profile repository based on the PRL information and obtaining the first profile information; a profile validator verifying the validity of the obtained first profile information; a profile analyzer analyzing and extracting the verified first profile information and the second profile information stored in the second profile repository; and a profile mapper creating new or additional profile information, which is optimized for the at least one RUI client, based on the profile information analyzed and extracted by the profile analyzer and providing the created new or additional profile information.

According to another aspect of the present invention, there is provided a profiling method used by an RUI server. The method includes: receiving first profiling request information; determining whether a terminal, which transmitted the first profiling request information, supports composite capabilities/preference profiles (CC/PP)-based profile information; accessing and obtaining first profile information of the terminal based on PRL information received from the terminal if it is determined that the terminal supports the CC/PP-based profile information; verifying the validity of the obtained first profile information; comparing and analyzing the verified first profile information and second profile information and extracting and converting corresponding profile information; and creating optimal first profiling response information based on the extracted and converted profile information and providing the optimal first profiling response information.

According to another aspect of the present invention, there is provided a profiling method used by an RUI server. The method includes: receiving first profiling request information; determining whether a terminal, which transmitted the first profiling request information, supports CC/PP-based profile information; accessing first profile information of the terminal based on PRL information received from the terminal and extracting valid information from the first profile information if it is determined that the terminal does not support the CC/PP profile information; analyzing new or additional profile information required for profiling based on the extracted information; creating new or additional profile information based on the analyzed profile information and converting the created new or additional profile information according to CC/PP-based rules; and creating the first profiling response information based on the created and converted, new or additional profile information and transmitting the created first profiling response information to the terminal.

### BRIEF DESCRIPTION OF DRAWINGS

FIG. 1 schematically illustrates the structure of a conventional Consumer Electronics Association (CEA)-2014 standard;

FIG. 2 illustrates an example of a remote user interface (RUI) profile based on the conventional CEA-2014 standard;

FIG. 3 illustrates the configuration of a network system for profiling an RUI according to an exemplary embodiment of the present invention;

FIG. 4 illustrates a composite capabilities/preference profiles (CC/PP)-based RUI profile according to an exemplary embodiment of the present invention;

FIG. 5 is a functional block diagram of an RUI client according to an exemplary embodiment of the present invention;

FIG. 6 is a functional block diagram of an RUI server according to an exemplary embodiment of the present invention; and

FIG. 7 is a flowchart illustrating an optimal profiling method used by an RUI server according to an exemplary embodiment of the present invention.

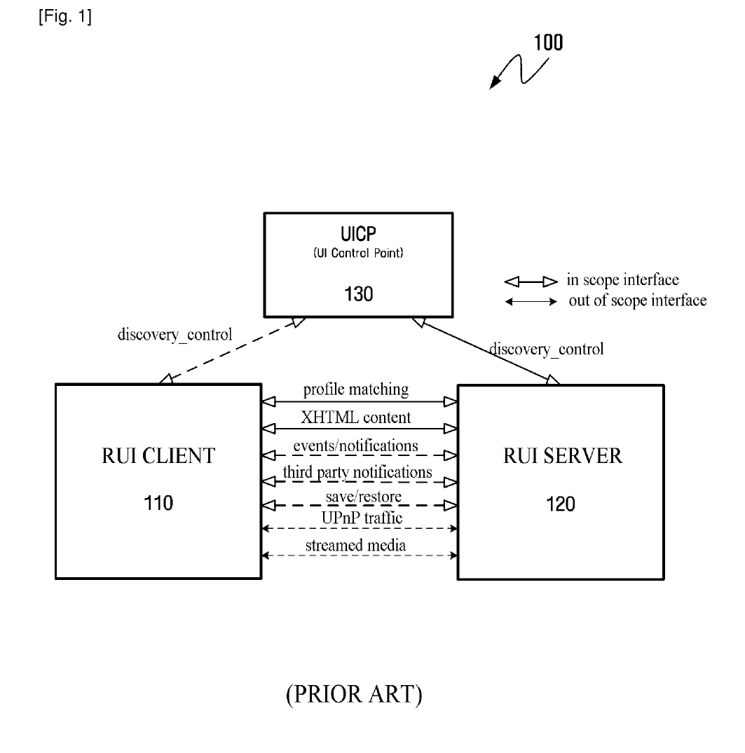

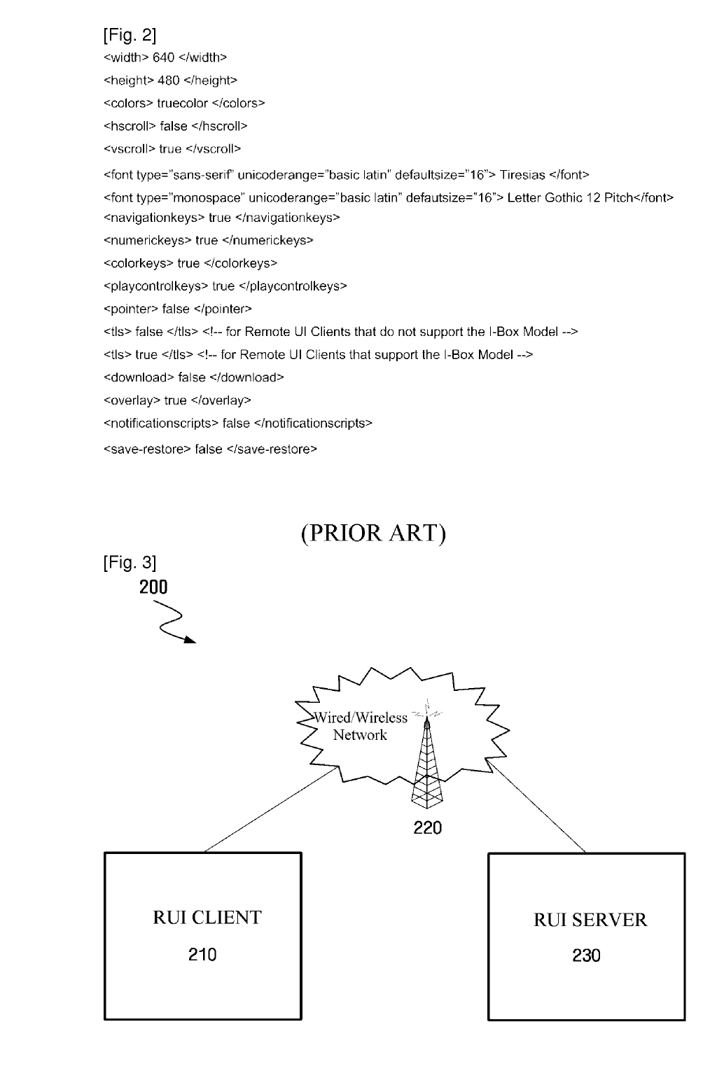

### MODE FOR THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims.

Composite capabilities/preference profiles (CC/PP), which was created by the Worldwide Web Consortium (W3C), is a standard for describing and transmitting user preference information and information regarding characteristics and constraints of a terminal, such as hardware characteristics, software characteristics, network characteristics, and services that are supported. Information regarding various device environments may be described by using profiles written in resource description framework (RDF).

The RDF profiles are classified into a CC/PP profile created by W3C, a user agent profile (UAProf) profile created by the Open Mobile Alliance (OMA), and a universal profiling schema (UPS) profile. These three types of RDF profiles are used to inform a server about devices which are increasing in capability and variety. An RDF data format is constructed as a 2-level hierarchy: a component at a higher level of the hierarchy and an attribute at a lower level. The RDF format must include correct extensible markup language (XML) and RDF syntax. A profile has one or more components, and each component has one or more attributes.

A CC/PP profile defines capabilities and preference information (CPI) of a client device in a standardized format, which is used to request web contents, and includes a hardware platform and a software platform as its major components.

Names and constraints of components and attributes of a CC/PP profile and data types are determined by a vocabulary which is a group of uniform resource identifiers (URIs). In the CC/PP standard, however, a specified vocabulary related to device independence is not designated. Instead, the CC/PP standard allows each application to define its own vocabulary and use the vocabulary to create a profile. Currently, most of the mobile devices that support the CC/PP standard are using a UAProf vocabulary developed by the Wireless Application Protocol (WAP) Forum to create their profiles.

The OMA designates a standard between a WAP device and a server by using UAProf profiles, and more effective content adaptation can be performed based on characteristics of the WAP device. A UAProf profile includes different components according to device capabilities. For example, the UAProf profile may include components specified in Table 1 below. However, the following components are limited to mobile devices, and a server and a proxy must use UAProf profiles.

TABLE 1
Components of UAProf vocabulary

| Component | Description |
|---|---|
| Hardware Platform | Describes hardware characteristics of a terminal |
| Software Platform | Describes an operating environment of a device |
| Browser UA | Describes a browser application of a device |
| Network Characteristics | Describes a network related structure |
| WAP Characteristics | Describes WAP capabilities of a terminal |
| Push Characteristics | Describes push specifications of a device |

A UPS (Universal Profiling Schema) has been suggested in order for content negotiation and multimedia adaptation which are not dependent on a particular device, protocol, or client model. The UPS profile is based on CC/PP and RDF and is classified into a network profile, a client profile and a server profile. Since the UPS profile considers characteristics of contents as well as those of a client, an adaptation and conversion method, and capabilities of a server, it can facilitate effective content adaptation in heterogeneous environments. In addition, the UPS profile allows the use of additional information or elements required for content negotiation, thereby improving profile extensibility.

FIG. 3 illustrates the configuration of a network system 200 for profiling a remote user interface (RUI) according to an exemplary embodiment of the present invention. Referring to FIG. 3, the network system 200 may include an RUI client 210, a network 220, and an RUI server 230.

The RUI client 210 and the RUI server 230 may be connected to each other by the network 220. The network 220 may be a home local area network (LAN), Internet, or any wired or wireless communication network having a bandwidth of various frequencies.

One or more RUI clients may be connected to one or more RUI servers. However, for simplicity, it will hereinafter be assumed that one RUI client is connected to one RUI server.

When the RUI client 210 is connected to the RUI server 230 by the network 220 to request a content service, the RUI client 210 and the RUI server 230 may share their own RUI profiles. The RUI client 210 may access the RUI server 230 by using a uniform resource locator (URL) or URI of the RUI server 230.

By sharing the RUI profiles, the RUI server 230 may obtain a client context provided by the RUI client 210, and the RUI client 210 may obtain a server context provided by the RUI server 230. Based on the client context, the RUI server 230 may find out about operating conditions of the RUI client 210 under which content services are provided. Based on the server context, the RUI client 210 may find out about the range of content services supported by the RUI server 230. For optimal adaptation of content which corresponds to the content service requested by the RUI client 210, the RUI server 230 and the RUI client 210 may go through content negotiation in which an optimal RUI profile is matched based on the server and client contexts. As a result, the RUI client 210 may display optimal content which corresponds to the requested content service.

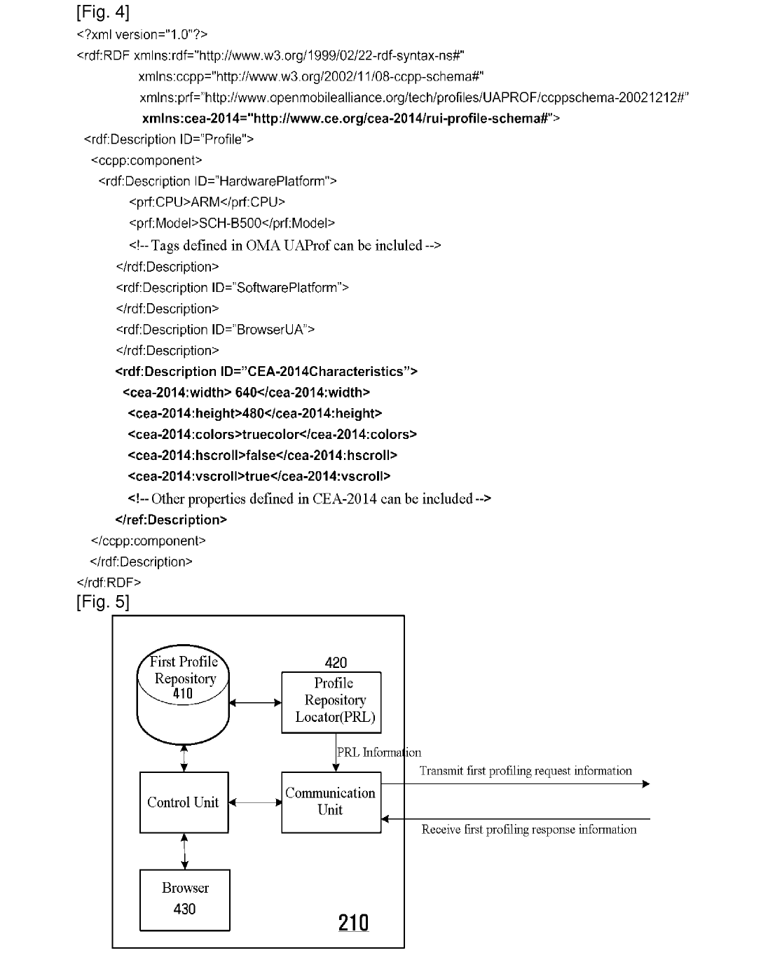

FIG. 4 illustrates a CC/PP-based RUI profile according to an exemplary embodiment of the present invention. Referring to FIG. 4, the CC/PP-based RUI profile according to the present embodiment is written in RDF which can be used for general purposes. The CC/PP-based RUI profile may define and contain hardware characteristics, such as the type (ARM) of a central processing unit (CPU) and a model name (SCH-B500), software characteristics, browser characteristics, and the type and version (XML 1.0) of a markup language. In addition, the CC/PP-based RUI profile may contain properties defined by a conventional Consumer Electronics Association (CEA)-2014 standard.

FIG. 5 is a functional block diagram of the RUI client 210 according to an exemplary embodiment of the present invention. Referring to FIG. 5, the RUI client 210 may include a first profile repository 410, a profile repository locator (PRL) 420, and a browser 430.

The first profile repository 410 may store and manage profile information of the RUI client 210. The PRL 420 may store location information of the first profile repository 410 and transmit the PRL information to the RUI server 230 when the RUI client 210 transmits a profiling request to the RUI server 230.

The browser 430 is a web browser which can be updated to transmit the location information of the first profile repository 410, to the RUI server 230 when the RUI client 210 transmits a profiling request to the RUI server 230 and which can display a page received from the RUI server 230 in response to the profiling request. For example, the browser 430 may be an XML or extensible hypertext markup language (XHTML) browser.

When the RUI client 210 transmits a profiling request to the RUI server 230 in order to display content desired by a user, the RUI server 230 may create response information in response to the profiling request and transmit optimized response information to the RUI client 210. The RUI server 230 may access the first profile information of the RUI client 210 by using the PRL information, which was received from the RUI client 210 together with the profiling request, and extract information required to create the response information from the first profile information.

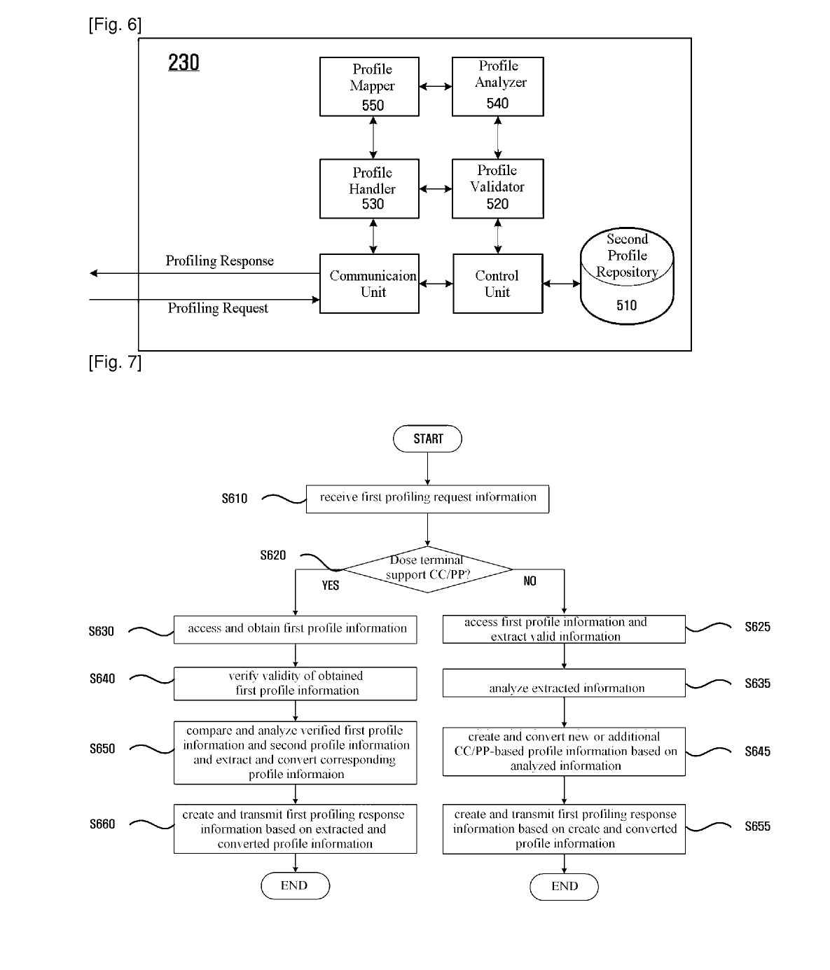

FIG. 6 is a functional block diagram of the RUI server 230 illustrated in FIG. 3.

Referring to FIG. 6, the RUI server 230 may include a second profile repository 510, a profile validator 520, a profile handler 530, a profile analyzer 540, and a profile mapper 550.

The second profile repository 510 may temporarily store and manage hardware, software and network characteristics of the RUI server 230. In addition, the second profile repository 510 may temporarily store and manage new information or information extracted from the first profile information to create response information which is to be sent to the RUI client 210 in response to a profiling request from the RUI client 210.

The profile validator 520 may verify the validity of first profiling request information received from the RUI client 210 when the RUI client 210 makes the profiling request. If the profile validator 520 determines that the first profiling request information is valid, the RUI server 230 may access the first profile repository 410 based on the PRL information and by using the profile handler 530 and obtain necessary information from the first profile information. The profile analyzer 540 may compare and analyze the first profile information obtained by using the profile handler 530 and the second profile information stored in the second profile repository 510 and extract information required to create response information for the profiling request.

Based on the information extracted by the profile analyzer 540, the profile mapper 550 may create new and additional profile information optimized for the RUI client 210.

The configuration and operation of the network system 200 for profiling a CC/PP-based RUI according to the present embodiment have been described above. Hereinafter, a method of profiling an optimal CC/PP-based RUI will be described in detail.

FIG. 6 is a flowchart illustrating an optimal profiling method used by the RUI server 230 according to an exemplary embodiment of the present invention. Referring to FIG. 7, the method may include receiving first profiling request information (operation S610), determining whether a terminal, which transmitted the first profiling request information, supports CC/PP-based profile information (operation S620), accessing and obtaining first profile information of the terminal based on PRL information received from the terminal if it is determined that the terminal supports the CC/PP-based profile information (operation S630), verifying the validity of the obtained first profile information (operation S640), comparing and analyzing the verified first profile information and second profile information, extracting and converting corresponding profile information (operation S650), and creating optimal first profiling response information based on the extracted and converted profile information and providing the optimal first profiling response information (operation S660).

In operation 5610, the first profiling request information may include the PRL information. The PRL information refers to the location information of the first profile repository 410 which stores the first profile information of the RUI client 210, that is, hardware, software and network characteristics of the RUI client 210, and user preference information.

In operations 5630 and 5625, the RUI server 230 may access the first profile repository 410 of the RUI client 210 based on the PRL information and obtain all or part of the first profile information. In operation 5640, the validity of the obtained first profile information may be verified.

In operation 5650, the verified first profile information and the second profile information, which is profile information of the RUI server 230, may be compared and analyzed, and then corresponding profile information may be extracted and converted.

The first and second profile information may be defined by a predetermined vocabulary and may be analyzed, extracted, created and converted according to rules of the vocabulary. A different vocabulary may be selected for each device, and attributes of each device may be easily inserted, modified, and deleted. Thus, a high level of device independence can be achieved.

In operation 5660, the first profiling response information may be created based on the extracted and converted profile information and transmitted to the terminal, i.e., the RUI client 210.

If it is determined in operation 5620 that the terminal does not support the CC/PP-based profile information, the method may include, after operation 5620, accessing the first profile information based on the PRL information and extracting only valid information from the first profile information (operation S625), analyzing new or additional profile information required for profiling on the extracted information (operation S635), creating new or additional profile information based on the analyzed profile information and converting the created new or additional profile information according to CC/PP-based rules (operation S645), and creating the first profiling response information based on the created and converted, new or additional profile information and transmitting the created first profiling response information to the terminal (operation S655).

That is, since the terminal does not support the CC/PP-based profile information, only valid information must be extracted from the first profile information of the terminal and then analyzed, and optimal profile information must be created based on the extracted and analyzed information.

Thus, as in operation 5630, the first profile information may be accessed by using the PRL information in operation 5625, and only valid information may be extracted. Then, new or additional profile information required for optimal profiling and a method of creating the new or additional profile information may be analyzed (operation S635). Next, new or additional profile information may be created based on the various analyzed data and converted according to the CC/PP-based rules (operation S645). Finally, the first profiling response information may be created based on created and converted, the new or additional profile information and then transmitted to the terminal (operation S655).

As described above, when various terminals, which are available now or will be available in the future, transmit CC/PP profiles that describe their characteristics, various content services can be easily provided in a device-independent manner. Consequently, time and costs required to develop content services can be sharply reduced since there is no need to develop different versions of the same content service according to terminals.

### INDUSTRIAL APPLICABILITY

A network system and method for creating and providing an RUI profile according to the present invention provide at least one of the following advantages.

When a CC/PP-based RUI profile according to the present invention is created, profiles defined by other standards can be utilized, which contributes to profile extensibility.

In addition, when the CC/PP-based RUI profile according to the present invention is used, compatibility of an RUI client and an RUI server can be enhanced.

Since the CC/PP-based RUI profile uses a general purpose RDF profile document structure, it can be easily analysed, and the usability of web application can be enhanced.

The term ‘unit’, as used herein, means, but is not limited to, a software or hardware component, such as a Field Programmable Gate Array (FPGA) or Application Specific Integrated Circuit (ASIC), which performs certain tasks. A unit may advantageously be configured to reside on the addressable storage medium and configured to execute on one or more processors. Thus, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or further separated into additional components and units.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

1. A network system for profiling a remote user interface (RUI), the network system comprising:
at least one RUI client; and
at least one RUI server receiving first profiling request information from the at least one RUI client and transmitting first profiling response information to the at least one RUI client in response to the received first profiling request information.

2. The network system of claim 1, wherein the at least one RUI client comprises:
a first profile repository storing and managing first profile information which is related to profile characteristics of the at least one RUI client;
a profile repository locator (PRL) storing PRL information which is location information of the first profile repository; and
a browser transmitting the first profiling request information and the PRL information when the at least one RUI client makes a profiling request, receiving the first profiling response information, and displaying the received first profiling response information.

3. The network system of claim 1 or 2, wherein the at least one RUI server comprises:
a second profile repository storing and managing second profile information, which is related to profile characteristics of the at least one RUI server, and new or additional information which may be created at the request of the at least one RUI client;
a profile handler accessing the first profile repository based on the PRL information and obtaining the first profile information;
a profile validator verifying the validity of the obtained first profile information;
a profile analyzer analyzing and extracting the verified first profile information and the second profile information stored in the second profile repository; and
a profile mapper creating new or additional profile information, which is optimized for the at least one RUI client, based on the profile information analyzed and extracted by the profile analyzer and providing the created new or additional profile information.

4. The network system of claim 2, wherein the first profile information comprises at least one of user preference information, hardware characteristics, software characteristics, and network characteristics of the at least one RUI client.

5. The network system of claim 2, wherein the browser is an extensible markup language (XML) browser or an extensible hypertext markup language (XHTML) browser.

6. The network system of claim 3, wherein the second profile information comprises at least one of new or additional information which may be created at the request of the at least one RUI client, hardware characteristics, software characteristics, and network characteristics of the at least one RUI server.

7. A profiling method used by an RUI server, the method comprising:
receiving first profiling request information;
determining whether a terminal, which transmitted the first profiling request information, supports composite capabilities/preference profiles (CC/PP)-based profile information;
accessing and obtaining first profile information of the terminal based on PRL information received from the terminal if it is determined that the terminal supports the CC/PP-based profile information;
verifying the validity of the obtained first profile information;
comparing and analyzing the verified first profile information and second profile information and extracting and converting corresponding profile information; and
creating optimal first profiling response information based on the extracted and converted profile information and providing the optimal first profiling response information.

8. A profiling method used by an RUI server, the method comprising:
receiving first profiling request information;
determining whether a terminal, which transmitted the first profiling request information, supports CC/PP-based profile information;
accessing first profile information of the terminal based on PRL information received from the terminal and extracting valid information from the first profile information if it is determined that the terminal does not support the CC/PP profile information;
analyzing new or additional profile information required for profiling based on the extracted information;
creating new or additional profile information based on the analyzed profile information and converting the created new or additional profile information according to CC/PP-based rules; and
creating the first profiling response information based on the created and converted, new or additional profile information and transmitting the created first profiling response information to the terminal.

9. The method of claim 7 or 8, wherein the first and second profile information is defined by a predetermined vocabulary and is analyzed, extracted, created and converted according to rules of the vocabulary.

10. The method of claim 9, wherein a different vocabulary can be selected for each device, and a high level of device independence can be achieved since profile attributes of each device can be easily inserted, modified, and deleted.
